(19) United States
(12) Patent Application Publication
(10) Pub. No.: US 2014/0238837 A1
(43) Pub. Date: Aug. 28, 2014

(54) CONTINUOUS TYPE WASTEWATER PURIFYING DEVICE

(71) Applicant: NATIONAL CHENG KUNG UNIVERSITY, Tainan (TW)

(72) Inventors: Jeng-Shiung Jan, Tainan (TW); Han-Ting Yen, Tainan (TW); Shuang-Yuan Chang, Tainan (TW); Meng-Hao Chuang, Tainan (TW); Shih-Kai Chou, Tainan (TW)

(73) Assignee: NATIONAL CHENG KUNG UNIVERSITY, Tainan (TW)

(21) Appl. No.: 14/012,200

(22) Filed: Aug. 28, 2013

(30) Foreign Application Priority Data
Feb. 27, 2013 (TW) 102106932

(51) Int. Cl. C02F 1/14

(52) U.S. Cl. CPC C02F 1/14
USPC 202/185.1; 202/235

(57) ABSTRACT

A continuous type wastewater purifying device includes a wastewater tank defining a predetermined level of wastewater received in the wastewater tank. A purifying piping unit is mounted on a base and includes a wastewater pipe, a purified water pipe, and at least one heat conduction pipe having an inlet end and an outlet end respectively connected to and in communication with the wastewater pipe and the purified water pipe. The wastewater pipe has a first height from a mounting portion of the base in a height direction. The purified water pipe has a second height from the mounting portion in the height direction. The second height is greater than the first height. The inlet end and the outlet end of the at least one heat conduction pipe has a height difference therebetween. The outlet end of the at least one heat conduction pipe is higher than the predetermined level.

### BACKGROUND OF THE INVENTION

1. Field of the Invention

The present invention relates to a wastewater purifying device and, more particularly, to a continuous type wastewater purifying device for continuously purifying wastewater.

2. Description of the Related Art

To reuse water resources, wastewater recycling apparatuses have been proposed and are available in the market to treat livelihood sewage or rainwater for effectively reducing waste of water resources.

FIG. 1 shows a solar heating device for producing purified water. The solar heating device 9 includes a liquid pipe 91, a vertical condensing portion 92 and a storage portion 93. The liquid pipe 91 is connected to a wastewater inlet 911 and a purified water overflow port 912. The liquid pipe 91 includes a heating portion 913 facing the sunlight to heat and evaporate wastewater flowing therethrough. The vertical condensing portion 92 condenses the purified water and the heated wastewater. The storage portion 93 is located on a bottom of the solar heating device 9 for collecting condensed purified water. An example of such a device is disclosed in Taiwan Patent Publication No. 201204638.

The wastewater is conveyed from the wastewater inlet 911 to the vertical condensing portion 92. In the vertical condensing portion 92, the wastewater flows through a heat exchange plate 94 and is conveyed by an internal pipe to a wastewater tank 95. The wastewater in the wastewater tank 95 is pressurized and conveyed by a pump to the heating portion 913 and is heated and evaporated by the sunlight into wastewater vapor that flows along the sloping heating portion 913. The wastewater vapor condenses into water drops that fall into the vertical condensing portion 92. Condensed purified water accumulates in the storage portion 93 and can be used via the purified water overflow port 912.

Although the solar heating device 9 can purify wastewater, the wastewater must be drawn by additional power, causing energy consumption during pressurization of the pump. In some occasions, wastewater can not be supplied in time and, thus causes limitation to the wastewater purification efficiency of the solar heating device 9. Furthermore, the solar heating device 9 is integral and occupies a considerable space. Namely, the solar heating device 9 can not be rearranged in response to different situations, providing limited utility. Further, the costs will be significantly increased and, thus impractical if several sets of solar heating devices 9 are used with an intension of increasing the wastewater purification efficiency. As a result, the wastewater purification efficiency can not be increased.

Thus, a need exists for a continuous type wastewater purifying device for treating livelihood water or rainwater as well as solving the above problems.

### SUMMARY OF THE INVENTION

The primary objective of the present invention is to provide a continuous type wastewater purifying device for continuously treating and purifying wastewater to increase the wastewater purification efficiency.

Another objective of the present invention is to provide a continuous type wastewater purifying device having a volume that can be increased or decreased in response to different situations, providing enhanced utility.

A further objective of the present invention is to provide a continuous type wastewater purifying device that can be easily assembled and detached, reducing the time and costs during the use.

The present invention fulfills the above objective by providing a continuous type wastewater purifying device including a wastewater tank adapted for receiving wastewater. The wastewater tank defines a predetermined level of the wastewater received in the wastewater tank. A base includes a mounting portion. A purifying piping unit is mounted on the base. The purifying piping unit includes a wastewater pipe, a purified water pipe, and at least one heat conduction pipe having an inlet end and an outlet end respectively connected to and in communication with the wastewater pipe and the purified water pipe. The wastewater pipe has a first height from the mounting portion in a height direction. The purified water pipe has a second height from the mounting portion in the height direction. The second height is greater than the first height. The inlet end and the outlet end of the at least one heat conduction pipe has a height difference therebetween in the height direction. The outlet end of the at least one heat conduction pipe is higher than the predetermined level in the height direction.

Preferably, the purified water pipe includes a stagnant end and a collecting end. The wastewater pipe includes a water inlet end and a water outlet end. The purified water pipe slants relatively to the wastewater pipe in a width direction perpendicular to the height direction. A minimum spacing between the collecting end and the water outlet end in the width direction is smaller than a minimum spacing between the stagnant end and the water inlet end in the width direction.

Preferably, the at least one heat conduction pipe has an inclination angle to the mounting portion of the base. The inclination angle is in proportion to a magnitude of the predetermined level in the height direction.

Preferably, an auxiliary heat absorbing member is mounted in the at least one heat conduction pipe. The auxiliary heat absorbing member is a metal coil having two ends respectively fixed to the outlet end and the inlet end of the at least one heat conduction pipe.

Preferably, a light concentrating member is mounted between the wastewater pipe and the purified water pipe. The light concentrating member is mounted on a sun-facing side of the at least one heat conduction pipe. The light concentrating member is an integral light concentrating plate.

In an example, the at least one heat conduction pipe includes a plurality of heat conduction pipes. A light concentrating member is mounted to a sun-facing side of each of the plurality of heat conduction pipes.

Preferably, the light concentrating member is a light concentrating lens of reflection type, refraction type, diffraction type, or combination type.

Preferably, the at least one heat conduction pipe includes a first side adjacent to the light concentrating member and a second side opposite to the first side. The first side is light-transmittable, and the second side is shielded from light.

Preferably, at least one condenser is mounted in the purified water pipe. The at least one condenser faces the outlet end of the at least one heat conduction pipe and is located in an ascending direction of wastewater vapor.

Preferably, the at least one condenser is an arcuate member made of ceramic material and having an arcuate condensing face.

Preferably, a water inlet valve is mounted on the water inlet end of the wastewater pipe. A water outlet valve is mounted on the water outlet end of the wastewater pipe. A flow control valve is mounted on the inlet end of the at least one heat conduction pipe connected to the wastewater pipe.

Preferably, the base is a frame having a peripheral frame. The wastewater pipe rests flatly on the mounting portion of the base and includes a longitudinal axis having the first height from the mounting portion. The purified water pipe is mounted on the peripheral frame and includes a longitudinal axis having the second height from the mounting portion.

Preferably, the at least one heat conduction pipe is made of high thermal conductivity material.

Preferably, the at least one heat conduction pipe is a transparent glass tube and receiving a photocatalyst.

Preferably, the wastewater pipe and the purified water pipe are made of stainless steel.

Preferably, the wastewater tank is connected to a raw water storage tank by a pipe. The raw water storage tank is a tower comprised of a plurality of detachable layers.

Preferably, the wastewater tank includes a level adjusting member. The level adjusting member includes a float and a float-controllable switch coupled to the float.

Preferably, the mounting portion is made of a material with reflective properties.

Preferably, the mounting portion includes a side facing the purifying piping unit. A reflective plate is bonded to the side of the mounting portion.

Preferably, a thermal insulating plate is bonded to the other side of the mounting portion opposite to the side bonded with the reflective plate

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a cross sectional view of a conventional solar heating device.

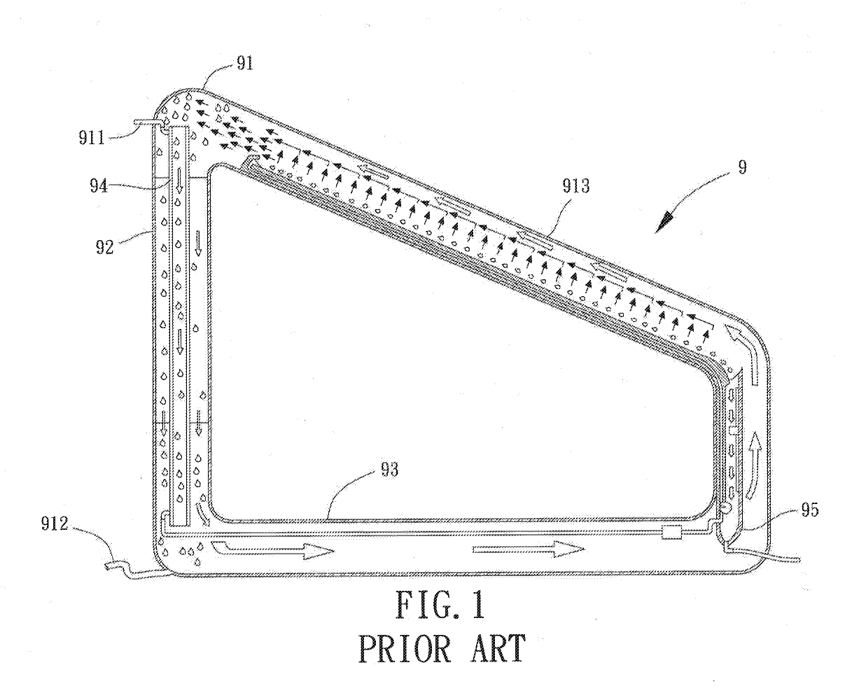

FIG. 2 shows a perspective view of a continuous type wastewater purifying device according to the present invention.

FIG. 3 shows an exploded, perspective view of a portion of the continuous type wastewater purifying device according to the present invention.

FIG. 4 shows a top view of the continuous type wastewater purifying device according to the present invention.

FIG. 5 shows a cross sectional view taken along section line 5-5 of FIG. 4.

FIG. 6 is a view similar to FIG. 5, illustrating operation of the continuous type wastewater purifying device according to the present invention.

FIG. 7 is a view similar to FIG. 6, illustrating use of the continuous type wastewater purifying device according to the present invention on a building.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

A continuous type wastewater purifying device according to the present invention can be used to recycle and purify various wastewater resources, such as household water and rainwater. The purified water obtained after treatment can be used for various purposes not for cleaning human bodies, such as for watering plants, household cleaning, etc.

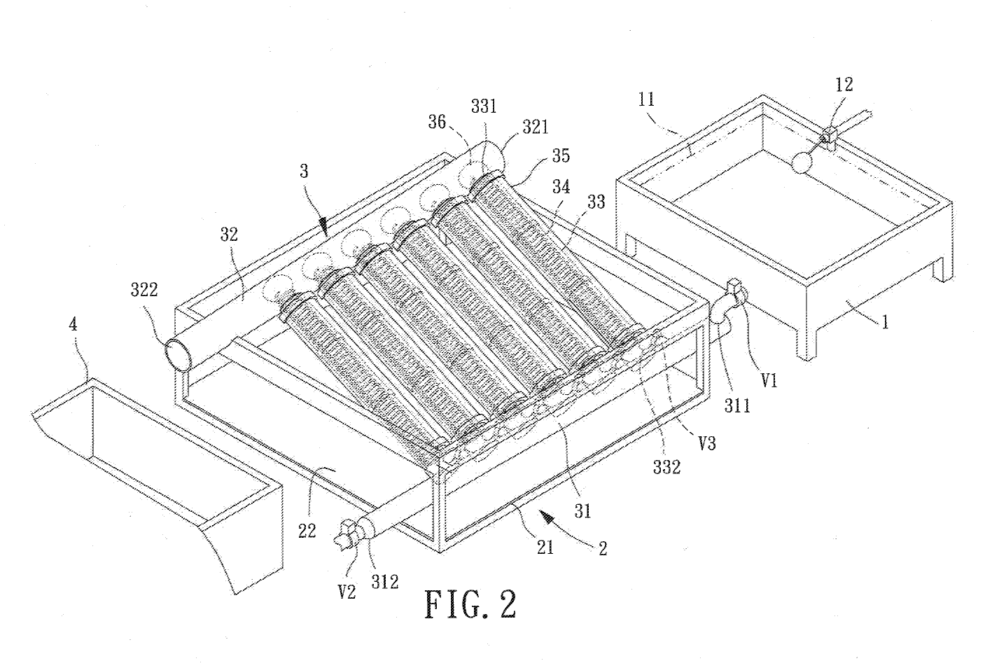

With reference to FIG. 2, a continuous type wastewater purifying device of an embodiment according to the present invention includes a wastewater tank 1, a base 2 and a purifying piping unit 3. The purifying piping unit 3 is mounted on the base 2 and is in communication with the wastewater tank 1 by a pipe.

The wastewater tank 1 can be any type of water container and is preferably mounted on or beside a building for collecting wastewater including but not limited to the household water in the building and rainwater falling on or beside the building. In the form shown, the wastewater tank 1 defines a predetermined level 11 that is the highest level of the wastewater received in the wastewater tank 1. The predetermined level 11 can be varied according to the amount of wastewater received in the wastewater tank 1. Preferably, the wastewater tank 1 includes a level adjusting member 12 in the form shown including a float 13 and a float-controllable switch 14 coupled to the float 13. In a case that the level of the wastewater in the wastewater tank 1 reaches the predetermined level 11, the buoyancy of float 13 shuts down the float-controllable switch 14 to stop feeding of external water into the wastewater tank 1, preventing overflow of wastewater while receiving sufficient amount of wastewater. Note that other types of the level adjusting member 12 can be used.

The wastewater tank 1 can be connected to a raw water storage tank by a pipe. Impurities carried by the wastewater can deposit in the raw water storage tank. The raw water storage tank can be a tower comprised of a plurality of detachable layers.

With reference to FIG. 2, the base 2 supports the purifying piping unit 3 and is preferably located on the same level as the wastewater tank 1, allowing the wastewater to flow from the wastewater tank 1 into the purifying piping unit 3 mounted on the base 2. Nevertheless, the wastewater tank 1 can be located above the base 2. The base 2 can be in the form of a frame, as shown in FIG. 2. In a case that the purifying piping unit 3 is mounted on top of a building, the roof of the building serves as the base 2. Nevertheless, the base 2 can be of any desired type for reliably supporting the purifying piping unit 3. In the form shown, the base 2 includes a mounting portion 21 at a bottom of the frame shown in FIG. 2. The mounting portion 21 is made of a material with reflective properties. Alternatively, a reflective plate 22 is bonded to a side of the mounting portion 21 facing the purifying piping unit 3 to reflect and concentrate the sunlight onto the purifying piping unit 3. Furthermore, a thermal insulating plate can be bonded to the other side of the mounting portion 21 opposite to the side bonded with the reflective plate 22.

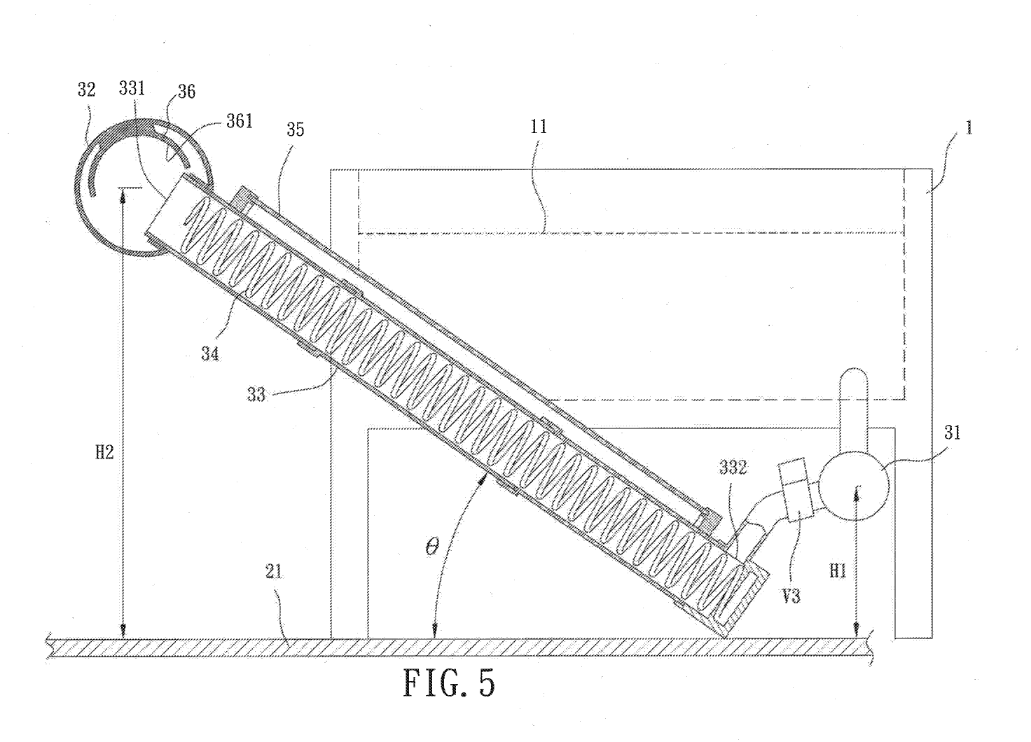

With reference to FIGS. 2 and 5, the purifying piping unit 3 mounted on the base 2 includes a wastewater pipe 31, a purified water pipe 32, and at least one heat conduction pipe 33 having an inlet end 332 and an outlet end 331 respectively connected to and in communication with the wastewater pipe 31 and the purified water pipe 32. The wastewater pipe 31 is in communication with the wastewater tank 1. In the form shown, the wastewater pipe 31 is located above the mounting portion 21 of the base 2 and includes a longitudinal axis having a first height H1 from the mounting portion 21 in a height direction. The wastewater pipe 31 may also rest flatly on the mounting portion 21 of the base 2. The purified water pipe 32 is mounted on a peripheral frame of the base 2 and includes a longitudinal axis having a second height H2 from the mounting portion 21 in the height direction. The second height H2 is larger than the first height H1 (FIG. 5). Thus, the whole purifying piping unit 3 is inclined, wherein the inlet end 332 and the outlet end 331 of the heat conduction pipe 33 has a height difference therebetween in the height direction. An inclination angle θ between the purifying piping unit 3 and the mounting portion 21 of the base 2 is in proportion to a magnitude of the predetermined level 11, assuring the outlet end 331 of the heat conduction pipe 33 connected to the purified water pipe 32 to be higher than the predetermined level 11 of the wastewater tank 1 in the height direction. According to the principle of communicating vessels, the level of wastewater in the heat conduction pipe 33 will be the same as that of wastewater in the wastewater tank 1, preventing wastewater from overflowing through the heat conduction pipe 33.

With reference to FIG. 2, a water inlet valve V1 is mounted on the water inlet end 311 of the wastewater pipe 31 connected to the wastewater tank 1. A water outlet valve V2 is mounted on a water outlet end 312 of the wastewater pipe 31. The water inlet valve V1 controls feeding of wastewater from the wastewater tank 1. The water outlet valve V2 controls effluent of wastewater. Furthermore, a flow control valve V3 is mounted on the inlet end 332 of the heat conduction pipe 33 connected to the wastewater pipe 31. The flow control valve V3 controls feeding of wastewater to the heat conduction pipe 33. In a case that a plurality of heat conduction pipes 33 is used, as shown in FIG. 2, a flow control valve V3 is mounted on the inlet end 332 of each heat conduction pipe 33. These flow control valves V3 can be used to control wastewater segregation while allowing closing of any one of heat conduction pipes 33 for cleaning or replacement purposes.

The wastewater pipe 31 and the purified water pipe 32 can be made of stainless steel (having a thermal conductivity of about 50 W/mK) to increase the temperature of wastewater before entering the heat conduction pipe 33. An obvious temperature decreasing effect can be obtained when the purified water pipe 32 is shielded, increasing the condensing effect of condensing vapor into water drops. Alternatively, the heat conduction pipe 3 can be a tube made of high thermal conductivity to maintain the solar heat absorbing effect. In another example, the heat conduction pipe 33 can be made of transparent glass. In the form shown, the heat conduction pipe 33 has a transmittance of about 73%. Furthermore, the heat conduction pipe 33 can receive a photocatalyst for deodorization and disinfection while purifying water.

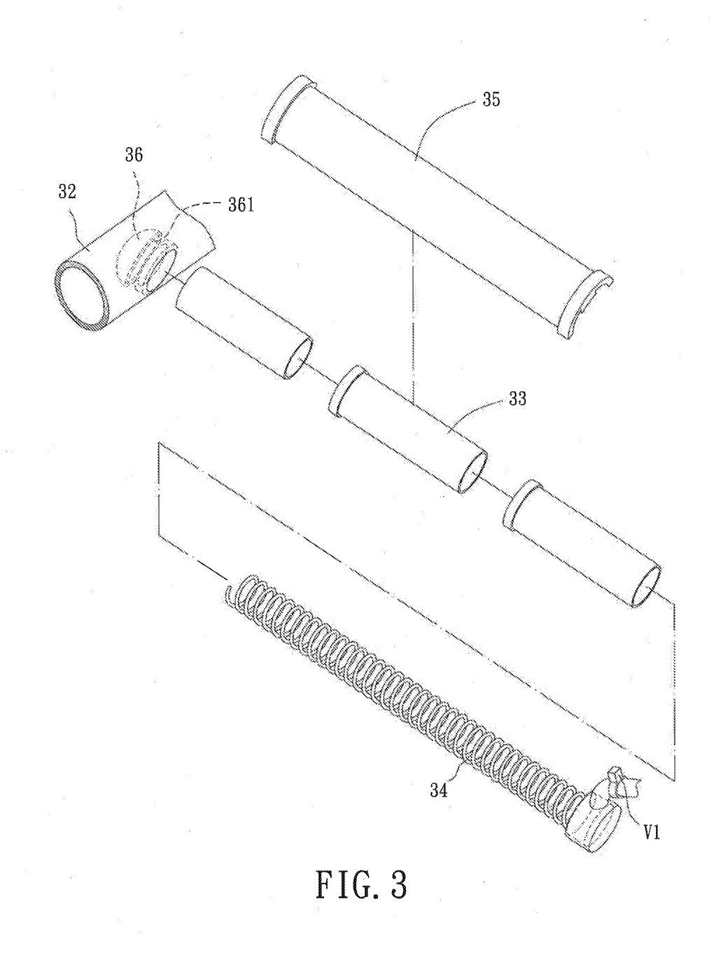

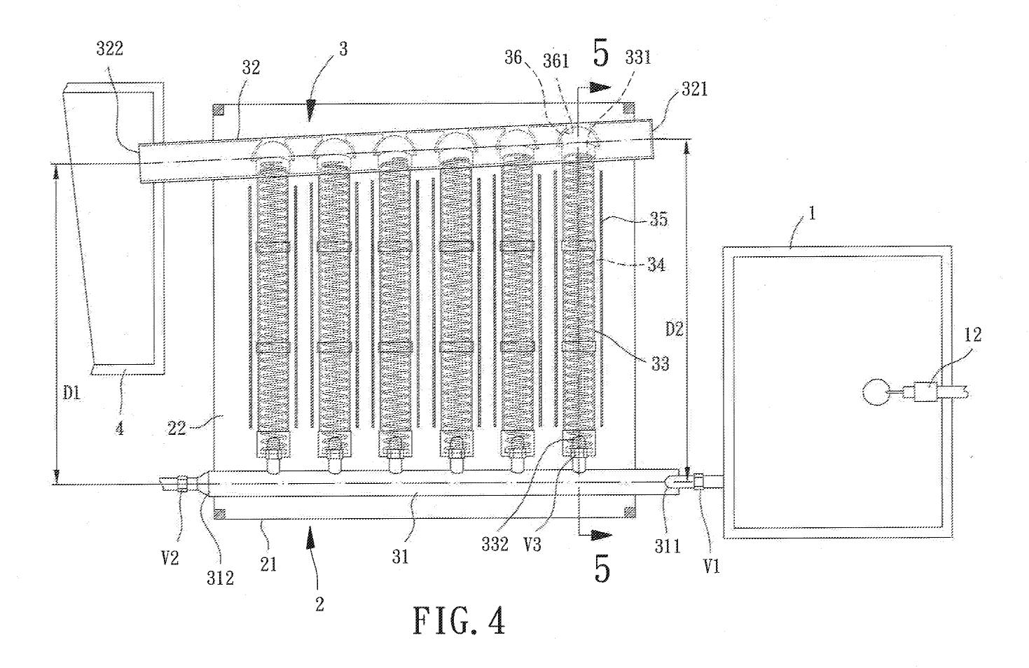

With reference to FIGS. 3 and 4, the heat conduction pipe 33 can be detachable tubes assembled through tightening, screwing, etc. to allow easy assembly, replacement and cleaning of the heat conduction pipe 33. The heat conduction pipe 33 further receives an auxiliary heat absorbing member 34. In the form shown, the auxiliary heat absorbing member 34 is a metal coil having two ends respectively fixed to the outlet end 331 and the inlet end 332 of the heat conduction pipe 33 by any suitable provisions. Thus, the wastewater in the heat conduction pipe 33 can be maintained at a desired temperature allowing easy evaporation. Furthermore, a light concentrating member 35 can be mounted between the wastewater pipe 31 and the purified water pipe 32. The light concentrating member 35 can be an integral light concentrating plate. In a case that the purifying piping unit 3 includes a plurality of heat conduction pipes 33, a light concentrating member 35 is mounted around each heat conduction pipe 33. The light concentrating member 35 can be a light concentrating lens of reflection type, refraction type, diffraction type or combination type, and is preferably of reflective type having a large incident field angle tolerance and adequate heat collecting efficiency. In the form shown, each light concentrating member 35 is mounted to a sun-facing side of a corresponding heat conduction pipe 33 to reflect the sunlight to a specific portion of the heat conduction pipe 33. The light concentrating member 35 can be fixed to a peripheral wall of the heat conduction pipe 33 by any suitable provision or stand on the mounting portion 21 of the base 2 to embrace the heat conduction pipe 33. Furthermore, a side of the heat conduction pipe 33 adjacent to the light concentrating member 35 can be light-transmittable such that the sunlight can pass through the heat conduction pipe 33 and activate the photcatalyst in the heat conductin pipe 33. The other side of the heat conduction pipe 33 opposite to the light-transmittable side can be shielded from light to completely absorb the radiated heat while radiated by the sun.

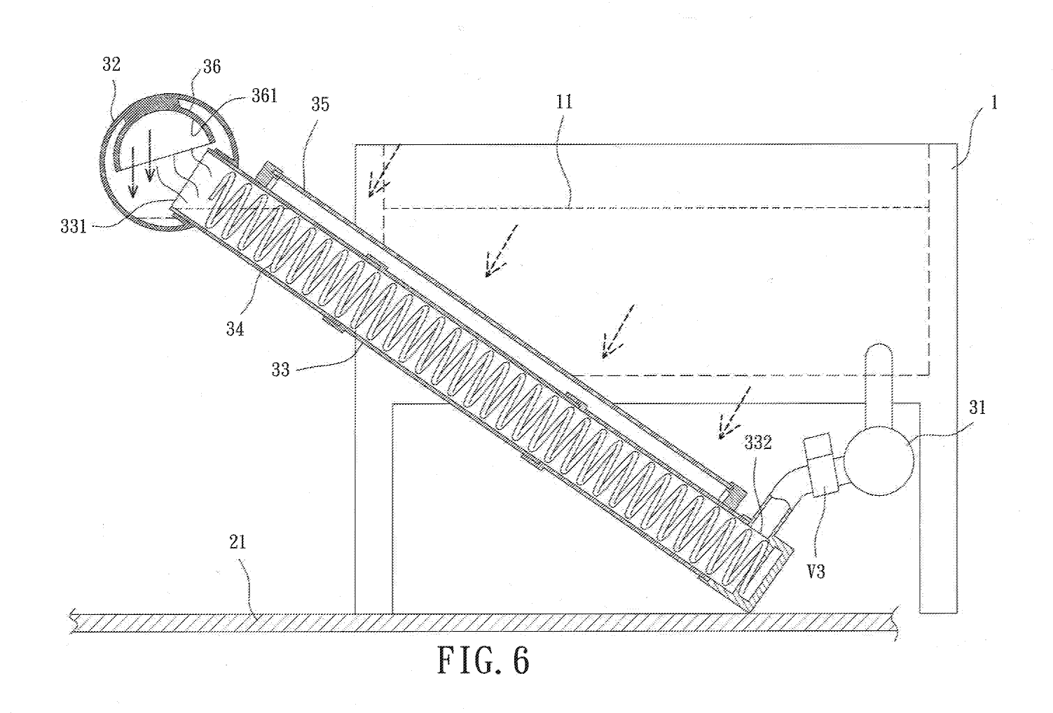

With reference to FIGS. 3 and 4, to rapidly condense wastewater vapor into water drops, the purified water pipe 32 further receives at least one condenser 36. The condenser 36 faces the outlet end 331 of the heat conduction pipe 33 and is preferably located in an ascending direction of wastewater vapor (FIG. 6). The condenser 36 has a condensing face 361 (FIG. 4) confronting wastewater vapor. The wastewater vapor rapidly condenses into water drops when in contact with the condensing face 361, and the water drops are discharged via the purified water pipe 32. The condenser 36 can be an arcuate member made of ceramic material and having an arcuate condensing face 361 for effectively concentrating wastewater vapor.

To allow the water drops collected in the purified water pipe 32 to flow from a stagnant end 321 of the purified water pipe 32 to a collecting end 322 of the purified water pipe 32 opposite to the stagnant end 321 and to be discharged via the collecting end 322, the purified water pipe 32 slants relatively to the wastewater pipe 31 in a width direction perpendicular to the height direction. A minimum spacing D1 between the collecting end 322 and the water outlet end 312 in the width direction is smaller than a minimum spacing D2 between the stagnant end 321 and the water inlet end 311 in the width direction. Specifically, referring to FIG. 4, the collecting end 322 of the purified water pipe 32 slants slightly downwards relatively to the stagnant end 321 of the purified water pipe 32 in the width direction. Thus, the condensed water collected in the purified water pipe 32 can be discharged via the collecting end 322 and preferably conveyed continuously to a clean water tank 4 for use by users. In another embodiment, the collecting end 322 of the purified water pipe 32 may slant slightly downwards relatively to the stagnant end 321 of the purified water pipe 32 in the height direction. In other words, the collecting end 322 of the purified water pipe 32 is located slightly lower than the stagnant end 321 of the purified water pipe 32.

With reference to FIGS. 4 and 5, in use of the continuous type wastewater purifying device according to the present invention for purifying wastewater in the wastewater tank 1 into purified water, the water inlet valve V1 and the flow control water V3 are opened while the water outlet valve V2 is closed, such that wastewater flows through the wastewater pipe 31 into the heat conduction pipes 33. The level of wastewater in each heat conduction pipe 33 is the same as that of wastewater in the wastewater tank 1, avoiding the level of the wastewater in each heat conduction pipe 33 to be higher than the predetermined level 11 in the wastewater tank 1, as shown in FIG. 6. The sunlight is concentrated onto the heat conduction pipes 33 by the light concentrating members 35. The auxiliary heat absorbing member 34 in each heat conduction pipe 33 absorbs the radiated heat of the sunlight to evaporate the wastewater in each heat conduction pipe 33. The vapor flows upward through the outlet end 331 of each heat conduction pipe 33 into the purified water pipe 32 and condenses into water drops due to the temperature drop resulting from contact of the vapor with the condensers 36. The purified water drops in the purified water pipe 32 flows along the slanting purified water pipe 32 and passes through the collecting end 322 into the clean water tank 4.

After evaporation of the wastewater, wastewater is supplied from the wastewater tank 1 into the heat conduction pipes 33 with the level of wastewater in each heat conduction pipe 33 remaining the same as that of wastewater in the wastewater tank 1. After repeated operations, the water inlet valve V1 is closed, and the water outlet valve V2 is opened, so as to discharge the wastewater in the heat conduction pipes 33 for cleaning and reuse of the heat conduction pipes 33.

In view of the foregoing, the main feature of the continuous type wastewater purifying device according to the present invention is that by locating the outlet end 331 of each heat conduction pipe 33 connected to the purified water pipe 32 at a position higher than the predetermined level 11 of the wastewater tank 1, the inclination angle θ of each heat conduction pipe 33 can be adjusted according to the magnitude of the predetermined level 11. Thus, no extra energy consumption is required to convey the wastewater from the wastewater tank 1 into the heat conduction pipe 33, maintaining continuous cycling of water while avoiding overflow from the heat conduction pipes 33. As a result, the continuous type wastewater purifying device according to the present invention not only saves extra power consumption but improves the wastewater purification effect through continuous wastewater supply. Furthermore, the continuous type wastewater purifying device according to the present invention can be rearranged according to differing needs at different locations through the use of a single or multiple heat conduction pipes 33, maintaining an appropriate amount of purified wastewater. The utility is enhanced while allowing easy assembly and detachment of the heat conduction pipes 33 according to needs, reducing the time and costs during the use.

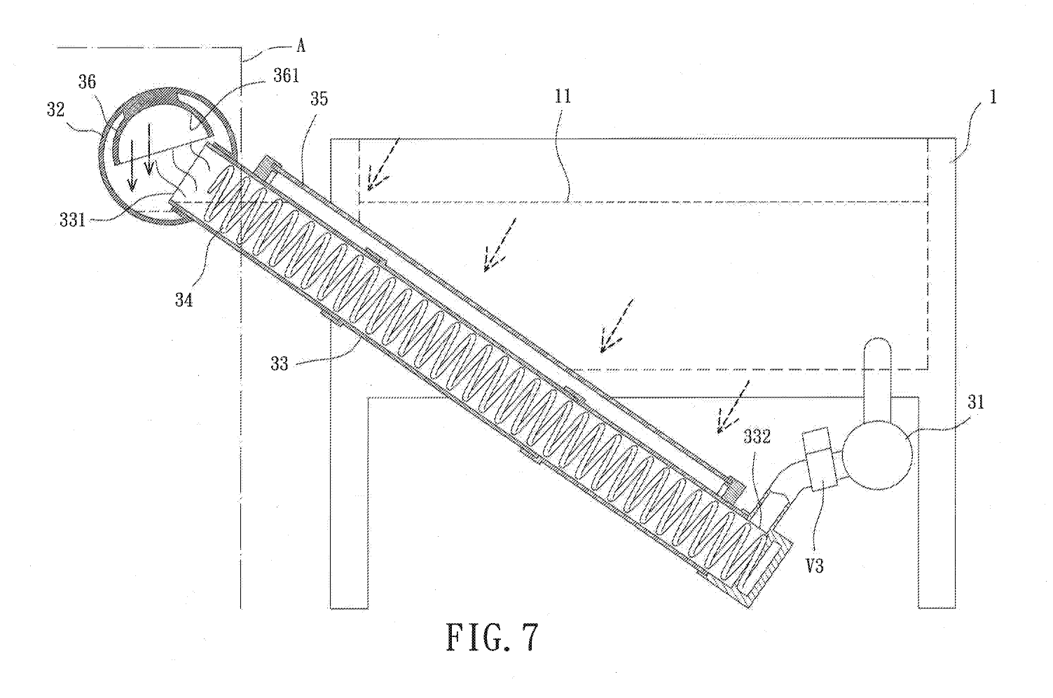

With reference to FIG. 7, the continuous type wastewater purifying device according to the present invention can be directly applied to a modern building and is preferably mounted on a roof of a building (A). The heat conduction pipes 33 are located outside of the building (A) (the right side of the building (A) shown by phantom lines) to be effectively heated by the sunlight to maximize the evaporation of wastewater. Furthermore, the purified water pipe 32 can be mounted inside and, thus, shielded by the building (A), effectively using the temperature difference between the inside and the outside of the building (A) such that the wastewater vapor can rapidly condense into water drops due to significant temperature drop, and the water drops can be collected for use by persons in the building A. The continuous type wastewater purifying device according to the present invention can be mounted to any location of a building to receive radiation from the sunlight, achieving enhanced water purification efficiency.

The continuous type wastewater purifying device according to the present invention can continuously treat and purify wastewater to increase the wastewater purification efficiency. Furthermore, the volume of the continuous type wastewater purifying device according to the present invention can be increased or decreased in response to different situations, providing enhanced utility. Further, the continuous type wastewater purifying device according to the present invention can be easily assembled and detached, reducing the time and costs during the use.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A continuous type wastewater purifying device comprising:
a wastewater tank adapted for receiving wastewater, with the wastewater tank defining a predetermined level of the wastewater received in the wastewater tank;
a base including a mounting portion; and
a purifying piping unit mounted on the base, with the purifying piping unit including a wastewater pipe, a purified water pipe, and at least one heat conduction pipe having an inlet end and an outlet end respectively connected to and in communication with the wastewater pipe and the purified water pipe, with the wastewater pipe having a first height from the mounting portion in a height direction, with the purified water pipe having a second height from the mounting portion in the height direction, with the second height greater than the first height, with the inlet end and the outlet end of the at least one heat conduction pipe having a height difference therebetween in the height direction, with the outlet end of the at least one heat conduction pipe being higher than the predetermined level in the height direction.

2. The continuous type wastewater purifying device as claimed in claim 1, with the purified water pipe including a stagnant end and a collecting end, with the wastewater pipe including a water inlet end and a water outlet end, with the purified water pipe slanting relative to the wastewater pipe in a width direction perpendicular to the height direction, with a minimum spacing between the collecting end and the water outlet end in the width direction being smaller than a minimum spacing between the stagnant end and the water inlet end in the width direction.

3. The continuous type wastewater purifying device as claimed in claim 1, with the at least one heat conduction pipe having an inclination angle to the mounting portion of the base, with the inclination angle being in proportion to a magnitude of the predetermined level in the height direction.

4. The continuous type wastewater purifying device as claimed in claim 2, with the at least one heat conduction pipe having an inclination angle to the mounting portion of the base, with the inclination angle being in proportion to a magnitude of the predetermined level in the height direction.

5. The continuous type wastewater purifying device as claimed in claim 1, further comprising: an auxiliary heat absorbing member mounted in the at least one heat conduction pipe, with the auxiliary heat absorbing member being a metal coil having two ends respectively fixed to the outlet end and the inlet end of the at least one heat conduction pipe.

6. The continuous type wastewater purifying device as claimed in claim 1, further comprising: a light concentrating member mounted between the wastewater pipe and the purified water pipe, with the light concentrating member mounted on a sun-facing side of the at least one heat conduction pipe, with the light concentrating member being an integral light concentrating plate.

7. The continuous type wastewater purifying device as claimed in claim 1, with the at least one heat conduction pipe including a plurality of heat conduction pipes, with a light concentrating member mounted to a sun-facing side of each of the plurality of heat conduction pipes.

8. The continuous type wastewater purifying device as claimed in claim 6, with the light concentrating member being a light concentrating lens of reflection type, refraction type, diffraction type or combination type.

9. The continuous type wastewater purifying device as claimed in claim 7, with the light concentrating member being a light concentrating lens of reflection type, refraction type, diffraction type or combination type.

10. The continuous type wastewater purifying device as claimed in claim 6, with the at least one heat conduction pipe including a first side adjacent to the light concentrating member and a second side opposite to the first side, with the first side being light-transmittable, with the second side being shielded from light.

11. The continuous type wastewater purifying device as claimed in claim 7, with the at least one heat conduction pipe including a first side adjacent to the light concentrating member and a second side opposite to the first side, with the first side being light-transmittable, with the second side being shielded from light.

12. The continuous type wastewater purifying device as claimed in claim 1, further comprising: at least one condenser mounted in the purified water pipe, with the at least one condenser facing the outlet end of the at least one heat conduction pipe and located in an ascending direction of wastewater vapor.

13. The continuous type wastewater purifying device as claimed in claim 12, with the at least one condenser being an arcuate member made of ceramic material and having an arcuate condensing face.

14. The continuous type wastewater purifying device as claimed in claim 1, further comprising: a water inlet valve mounted on the water inlet end of the wastewater pipe; a water outlet valve mounted on the water outlet end of the wastewater pipe; and a flow control valve mounted on the inlet end of the at least one heat conduction pipe connected to the wastewater pipe.

15. The continuous type wastewater purifying device as claimed in claim 1, with the base being a frame, with the wastewater pipe located above the mounting portion of the base and including a longitudinal axis having the first height from the mounting portion, with the base including a peripheral frame, with the purified water pipe mounted on the peripheral frame and including a longitudinal axis having the second height from the mounting portion.

16. The continuous type wastewater purifying device as claimed in claim 1, with the at least one heat conduction pipe made of high thermal conductivity material.

17. The continuous type wastewater purifying device as claimed in claim 1, with the at least one heat conduction pipe being a transparent glass tube and receiving a photocatalyst.

18. The continuous type wastewater purifying device as claimed in claim 1, with the wastewater pipe and the purified water pipe made of stainless steel.

19. The continuous type wastewater purifying device as claimed in claim 1, with the wastewater tank connected to a raw water storage tank by a pipe, with the raw water storage tank being a tower comprised of a plurality of detachable layers.

20. The continuous type wastewater purifying device as claimed in claim 1, with the wastewater tank including a level adjusting member, with the level adjusting member including a float and a float-controllable switch coupled to the float.

21. The continuous type wastewater purifying device as claimed in claim 1, with the mounting portion made of a material with reflective properties.

22. The continuous type wastewater purifying device as claimed in claim 1, with the mounting portion including a side facing the purifying piping unit, with a reflective plate bonded to the side of the mounting portion.

23. The continuous type wastewater purifying device as claimed in claim 22, with the mounting portion including another side opposite to the side bonded with the reflective plate, with a thermal insulating plate bonded to the other side of the mounting portion.
